(19) United States
(12) Patent Application Publication
(10) Pub. No.: US 2002/0027954 A1
(43) Pub. Date: Mar. 7, 2002

(54) METHOD AND DEVICE FOR GATHERING BLOCK STATISTICS DURING INVERSE QUANTIZATION AND ISCAN

(76) Inventors: KENNETH S. SINGH, HARRIMAN, NY (US); EBERHARD FISCH, SUNNYVALE, CA (US)

Correspondence Address: CORPORATE PATENT COUNSEL, U S PHILIPS CORPORATION, 580 WHITE PLAINS ROAD, TARRYTOWN, NY, 10591

(21) Appl. No.: 09/107,522

(22) Filed: Jun. 30, 1998

(51) Int. Cl. H04N 7/12

(52) U.S. Cl. 375/240.03

(57) ABSTRACT

A method and device for reducing the average number of computations required for inverse discrete cosine transform by gathering block statistics during inverse quantization and inverse scan. These statistics include the location and frequency of sub-blocks containing non-zero, DC coefficients, the location of rows and columns that contain non-zero DCT coefficients, the dynamic range of the block, etc.

### BACKGROUND OF THE INVENTION

1. Field of the Invention

This invention relates in general to video decoding and in particular to reducing the average number of computations required for inverse discrete cosine transformation by collecting block statistics during inverse quantization and inverse scan.

2. Description of the Prior Art

In an MPEG decoder, compressed video data is subjected to a series of transformations as part of the decoding process. The typical MPEG video decoder performs the following operations to decompress the video stream: fixed length decoding (FLD), variable length decoding (VLD), run length decoding (RLD), inverse differential pulse code modulation and inverse quantization (IDPCM, IQ), inverse discrete cosine transformation (IDCT), and motion compensation (MC). (It should be noted that the term MPEG, used herein, refers to MPEG1, MPEG2 and MPEG4.)

Along with VLD and motion compensation, IDCT is one of the most computationally intensive blocks in the decoding chain. There are more than 30 fast IDCT algorithms, and typically one IDCT algorithm is chosen to decode all of the 8×8 blocks of DCT coefficients within a video stream. The choice of this algorithm is usually based on the computational complexity of the entire video stream. Since IDCT is a bottleneck, it is worthwhile to reduce the average number of computations in this transformation.

### SUMMARY OF THE INVENTION

It is an object of the invention to lessen the computational complexity and improve the efficiency of the MPEG decoding algorithm by gathering block statistics which can be used by the IDCT stage to reduce the number of computations during IDCT. Since the inverse quantization (IQ) phase processes video frames one block at a time and it must look at each non-zero coefficient and scale the non-zero coefficients (up) and reorder them in preparation for IDCT, it is a perfect time to gather statistics about a block. Many types of block statistics such as the quadrants that contain non-zero coefficients, the rows and columns that contain non-zero coefficients, and the dynamic range within the block, can be gathered during IQ\SCAN which can be used to improve the efficiency of IDCT.

MPEG decoders deal with quantized blocks of DCT coefficients derived from video data. In video sources pixels tend to be highly correlated in the horizontal, vertical and temporal dimensions. In fact, this is the very reason why the MPEG2 standard achieves such high compression rates. To take advantage of this correlation, the invention in a first embodiment classifies the input data blocks into a small number of classes based on the location and frequency of sub-blocks having non-zero valued DCT coefficients. Each data block falls into one of the classes. For each class, the particular fast algorithm that best exploits the pattern of non-zero sub-blocks of that class is selected.

In another aspect of this first embodiment of the invention, the probability of occurrence for each class is estimated empirically and only a select group of optimal algorithms for the classes that are most likely to occur are stored for use. For those classes that are least likely to occur, a default algorithm is stored. This default algorithm is not optimized for any one class.

In yet another aspect of this first embodiment the algorithm can be further modified to eliminate unnecessary computations based on the structure of the DCT coefficient blocks in the class. In this aspect of the invention additions, subtractions and multiplications are eliminated for those sub-blocks containing only zero valued DCT coefficients.

Since the invention only needs the locations of the non-zero coefficients within the block, the blocks are classified by directly using the DCT coefficients encoded in run level format. In a preferred embodiment of the invention, the 8×8 blocks are divided into four 4×4 sub-blocks. The classification of the blocks is based on the location, within the 8×8 block, of the sub-blocks that contain non-zero DCT coefficients.

In a second embodiment of the invention, the row and column location of each non-zero coefficient in a block is determined during IQ/ISCAN. Each row or column in the inverse scanned matrix which contains a non-zero coefficient is represented by a set bit in an 8-bit bit vector. Two vectors are generated: one vector is a row histogram and one vector is a column histogram. The least populated histogram (row or col) is then sent to the IDCT phase. This histogram information improves the IDCT computational efficiency by indicating which rows (if the row histogram is the least populated otherwise the columns if the column histogram is the least populated) contain non-zero coefficients and only performing IDCT on these rows (columns). An optimal IDCT algorithm can then be chosen which is most computationally efficient for the particular histogram.

In a third embodiment of the invention the dynamic range or the difference between the smallest and the largest coefficient in a block is determined during IQ/ISCAN. Again this information can be passed to the IDCT phase thereby improving the efficiency of IDCT by choosing the most efficient IDCT algorithm for the particular dynamic range.

Accordingly it is an object of the invention to obtain block statistics during IQ/ISCAN to thereby improve the efficiency of IDCT.

It is another object of the invention to classify data blocks based on the location and frequency of the zero valued DCT coefficients within a block and to select a fast IDCT algorithm based on the classification of a particular block.

It is yet another object of the invention to use the block classifications to eliminate unnecessary computations.

It is yet a further object of the invention to store those IDCT algorithms for block classifications which are most likely to occur in a cache memory and to store the algorithms for those block classifications that are least likely to occur in ordinary memory.

It is a further object of the invention to determine the probability of occurrence of particular classes and to select a few different optimal fast IDCT algorithms for the classes having the highest probability of occurrence, and to choose a default algorithm for the remaining classes.

It is yet a further object of the invention to determine the probability of occurrence of block classifications based on the incoming video stream and to update the cache memory with those IDCT algorithms which are most likely to be used.

It is yet another object of the invention to create row and column histograms which indicate the rows and columns of a block which contain non-zero DCT coefficients.

It is yet another object of the invention to determine the dynamic range of a block.

The invention accordingly comprises the several steps and the relation of one or more of such steps with respect to each of the others, and the apparatus embodying features of construction, combinations of elements and arrangement of parts which are adapted to effect such steps, all as exemplified in the following detailed disclosure, and the scope of the invention will be indicated in the claims.

### BRIEF DESCRIPTION OF THE DRAWINGS

For a more detailed understanding of the invention reference will be made to the following drawings:

FIG. 1 shows a block diagram of the block classification system;

FIG. 2 shows the block classification system, in accordance with another embodiment of the invention having a cache memory which stores optimal IDCT algorithms for classes having the highest probability of occurrence, which cache is updated with new IDCT algorithms from ordinary memory for classes that are least likely to occur;

FIG. 3 shows the block classification system in accordance with the invention with run-time updating of the cache memory with the algorithms that are most likely to be executed based on the incoming data stream;

FIG. 4 shows the histogram system in accordance with the invention; and

FIG. 5 shows a flow chart for computing the dynamic range of a block with the invention.

### DETAILED DESCRIPTION OF THE PREFERRED EMBODIMENTS

During IQ/ISCAN each non-zero coefficient is looked at to scale it and reorder it. Accordingly at this point in the decoding process many valuable statistics can be gathered about the location and frequency of occurrence of the DCT coefficients, as well as their values. This information can then be used by the IDCT block, which is typically the most computationally complex, to either choose a fast IDCT algorithm which is best suited for the statistics obtained during IQ/ISCAN, or alternatively to simply eliminate unnecessary computations in the IDCT process. The following embodiments describe some of the block statistics that can be gathered during IQ/ISCAN. There are obviously many other types of statistics that can also be gathered during IQ/ISCAN and used by the IDCT stage that is obvious to one of ordinary skill in the art. One of the important aspects of this invention is that these block statistics are gathered during IQ/ISCAN. The first embodiment of the invention will be described with reference to how the block statistics are gathered and how an IDCT algorithm is selected based on these statistics. It should be noted that the remaining embodiments can also be adapted for use with an IDCT algorithm selector.

### Block Classification Statistics

In a first embodiment of the invention, a DCT block classification system is described which creates classes of blocks based on the location and frequency of sub-blocks containing non-zero DCT coefficients during IQ/ISCAN. The criterion used to classify input data blocks will be described in terms of run length decoded and inverse scanned 8×8 blocks of DCT coefficients. It should be noted that there are many different ways to partition DCT coefficient blocks into classes. The following description uses a simple classification scheme based on the existence and location of 4×4 sub-blocks of zero valued DCT coefficients within the larger 8×8 block. Such a 4×4 zero sub-block will be denoted by 0.

$$0 = [ \begin{matrix}0 & 0 & 0 & 0 \\ 0 & 0 & 0 & 0 \\ 0 & 0 & 0 & 0 \\ 0 & 0 & 0 & 0\end{matrix} ]$$

An 8×8 block of DCT coefficients can be partitioned into 4 sub-blocks of size 4×4 as shown below:

$$B = [ \begin{matrix}{B}_{0} & {B}_{1} \\ {B}_{2} & {B}_{3}\end{matrix} ]$$

Each sub-block, Bᵢ, is just one of four possible quadrants in the larger 8×8 block B. If a video picture of a natural scene is partitioned into non-overlapping N×N blocks then typically a large number of these blocks will contain pixels that are highly correlated in both the vertical and horizontal dimensions. This is one of the reasons why such a high rate of data compression is possible in the MPEG2 compression scheme. If the pixels in a block are highly correlated in either the vertical or horizontal dimension, or in both dimensions, then after quantization, one or more of the sub-blocks B₁, B₂, B₃ will contain only zero valued DCT coefficients. This results in 8 possible configurations of zero sub-blocks within the larger block. We enumerate all the classes 0, 1, . . . 7 from left to right in the following figure:

| $[ \frac{{B}_{0 } 0}{0 \; 0} ] ,$ | $[ \frac{{B}_{0 } {B}_{1}}{0 \; 0} ] ,$ | $[ \frac{{B}_{0 } 0}{{B}_{2} 0} ] ,$ | $[ \frac{{B}_{0 } {B}_{1}}{{B}_{2} 0} ] ,$ | $[ \frac{{B}_{0 } {B}_{1}}{{B}_{2 } {B}_{3}} ] ,$ | $[ \frac{{B}_{0 } 0}{0 {B}_{3}} ] ,$ | $[ \frac{{B}_{0 } {B}_{1}}{0 {B}_{3}} ] ,$ | $[ \frac{{B}_{0 } 0}{{B}_{2} {B}_{3}} ]$ |
|---|---|---|---|---|---|---|---|
| 0 | 1 | 2 | 3 | 4 | 5 | 6 | 7 |

In video sources with highly correlated pixels a large percentage of the quantized blocks of DCT coefficients will have high order coefficients, which correspond to high frequency information, equal to zero. Assume, for the purpose of illustration, that 50% of the blocks have the structure corresponding to class 0, 10% fall in class 1, 5% in class 2, and the remaining block types occur 30% of the time. Also assume that the class 0 algorithm requires only ½ of the computations of the standard fast algorithm, class 2 and 3 require ¾ of the computations, and all the remaining blocks are processed with the standard fast algorithm. Under these assumptions the expected number of computations for the system would be

$$\frac{50}{100} \cdot ( \frac{1}{2} \cdot {C}_{0} ) + \frac{10}{100} ( \frac{3}{4} \cdot {C}_{0} ) + \frac{10}{100} ( \frac{3}{4} \cdot {C}_{0} ) + \frac{30}{100} \cdot {C}_{0} = \frac{70}{100} \cdot {C}_{0}$$

In the above case 30% fewer computations are required for the block classification scheme on the average. The matrices below show the composition of the 4 proposed block class types:

| | | | | | | | |
|---|---|---|---|---|---|---|---|
| $[ \frac{{B}_{0 } 0}{0 \; 0} ] ,$ | $[ \frac{{B}_{0 } {B}_{1}}{0 \; 0} ] ,$ | $[ \frac{{B}_{0 } 0}{{B}_{2} 0} ] ,$ | $[ \frac{{B}_{0 } {B}_{1}}{{B}_{2} 0} ] ,$ | $[ \frac{{B}_{0 } {B}_{1}}{{B}_{2 } {B}_{3}} ] ,$ | $[ \frac{{B}_{0 } 0}{0 {B}_{3}} ] ,$ | $[ \frac{{B}_{0 } {B}_{1}}{0 {B}_{3}} ] ,$ | $[ \frac{{B}_{0 } 0}{{B}_{2} {B}_{3}} ]$ |

| | | | | |
|---|---|---|---|---|
| CLASS# | 0 | 1 | 2 | 3 |

For each of the 4 classes a fast IDCT algorithm is chosen which takes advantage of the zero block configuration structure. Once having chosen such a fast algorithm for each class the system can further optimize each algorithm by eliminating all additions, subtractions, and multiplications involving data coefficients within the zero sub-blocks. The actual details of how the structure of each of the 4×4 sub blocks is determined is as follows.

As explained in copending application Ser. No. 08/996,670, hereby incorporated by reference, it is possible to carry out the inverse quantization processing step without carrying out the run/level expansion processing step. The resulting run/level representation is an efficient data structure, in terms of storage, for representing a sparse 8×8 block of data. In U.S. Ser. No. 08/996,670 the actual row major count of the non-zero DCT coefficient is represented in each run/level pair. (The row major count system is explained infra). In another aspect of this embodiment, a Cartesian coordinate system is used to determine the location of non-zero DCT coefficients. This Cartesian coordinate system is explained as follows:

Assume that in a particular block of DCT coefficients there are only 0<K<63 non-zero AC coefficients, the structure of the data for a given block would then be:

[dc],[R₁,L₁,S₁], [R₂L₂,S₂], . . . , [R_{K}, L_{K},S_{K}],EOB

where R₁ denotes the length of a run of zeros preceding a coefficient with magnitude L₁ with a sign bit S₁, and wherein dc denotes the dc coefficient which is always positioned at (0,0). The sequence of run/level data is a 1 dimensional representation of a 2 dimensional block obtained by applying either zig-zag or alternate scanning in an 8×8 block as described in the MPEG2 specification. The linear position or index location of the non-zero I-th coefficient in the 1 dimensional array can be computed by summing up the runs of zeros and non-zero coefficients up to the I-th non-zero level value in the above run level representation:

$$index [ {L}_{1} ] = 1 + {\sum }_{m = 1}^{i} ( {R}_{m} + 1 )$$

Using the MPEG2 inverse scan function, iscan[ ], which computes the inverse of the alt_scan or zig-zag scan, and the definition of the index[ ] function in the above equation the original two dimensional coordinates of the non-zero coefficient [R₁, Lᵢ, S₁] can be computed as

(m₁, n₁)=(└(iscan[alt_scan][index[L₁,]])/8┘, iscan[alt_scan][index[L₁]]MOD 8)

For example, suppose there are two non-zero ac coefficients in an 8×8 block of DCT coefficients and the block has the following structure:

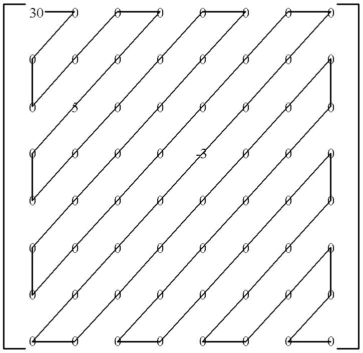

with zig-zag scanning, as indicated, the block would be encoded in run level format as the sequence:

30, [7,5 +1], [22, 3, −1], EOB

Using the equation for calculating (m₁, n₁) the two dimensional coordinates can be found. The dc coefficient has the coordinates (0, 0) of course. The computed coordinates of the non-zero coefficient with the value 5 are (2, 1) and the coordinates for −3 are (3, 4). Once the two dimensional coordinates of all the non-zero coefficients have been computed, the use of the following formula determines which of the four sub-blocks each coefficient belongs to:

$$quadrant [ {m}_{i} , {n}_{i} ] = ⌊ \frac{{m}_{i}}{4} ⌋ + ⌊ \frac{{n}_{i}}{4} ⌋$$

The function in the above formula takes on the values 0,1,2,3 corresponding to the sub-blocks B₀,B₁,B₂,B₃. Using either the above formula based on the Cartesian coordinates, or the row major count formula shown below we define the IDCT class membership function, class [ ]. For the block having non-zero coefficients at Cartesian coordinates (0, 0), (2, 1) and (3, 4) it is seen that this block falls into IDCT class 1 since the non-zero coefficients fall in the upper left and upper right quadrants only. A fast IDCT algorithm can then be chosen which is optimal for class 1. The system can also eliminate all additions, subtractions and multiplications which involve the lower ½ of the block since these coefficients are all zero. In a further embodiment of the invention the selected optimal algorithms are modified and stored such that computations involving the zero sub-blocks in the class are eliminated.

For a row major count system, the distribution of coefficients within each sub-block can be computed using the following row major count formula:

sub-block [rmc/(n²/2)][(rmc MODULO N)/(N/2)]+=1

where sub-block [ ] [ ] is a 2×2 array;

rmc is the row-major position of a coefficient in

the N×N matrix after ISCAN;

N is the number of elements per column or row;

/ is the integer division operator; and

=+1 implies increment by 1.

In this manner, four counts are generated, representing the number of coefficients that fall within each sub-block.

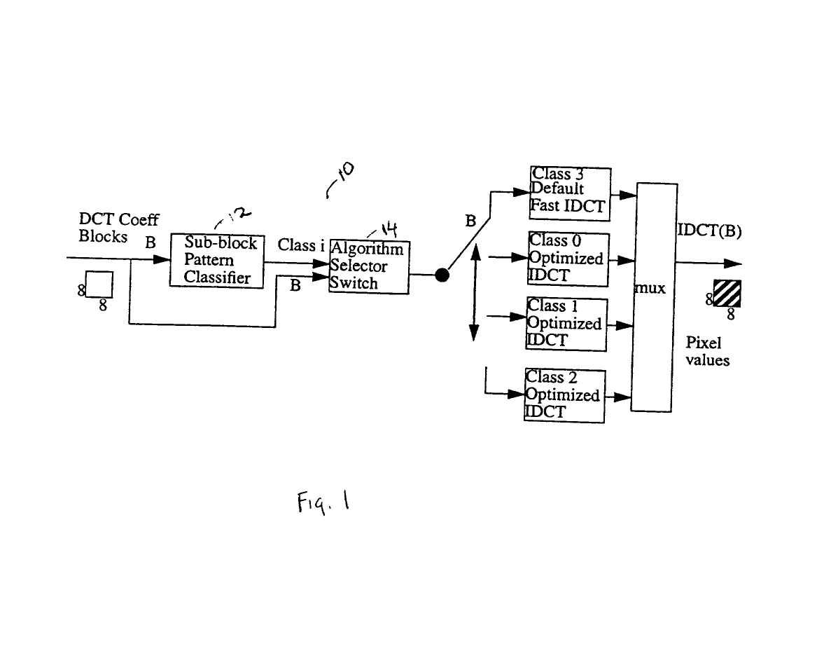

FIG. 1 shows a block diagram of the overall block classification system 10. Blocks, B, of DCT coefficients are input to sub-block classifier 12. The sub-block pattern classifier 12 determines in which class (0,1,2 or 3) the particular sub-block belongs. The output of the sub-block classifier 12 is the class index number, I, to which the block belongs. In FIG. 1 the block, B, is shown to belong to class 3, for which the default fast IDCT algorithm is used. The default fast algorithm makes no assumptions about the structure of the input data. If instead if the block had belonged to class 1, the switch 14 would route the block through the particular fast IDCT algorithm that is optimized for class 1.

In systems that use instruction cache memories there is often a significant penalty incurred when new executable code is loaded into this cache from external storage memory. The size of this cache is limited and it may only be possible to load enough code for a small number of optimized IDCT algorithms at any one time. In such a cache based platform the block classification based IDCT system is only practical for a small number of classes. To reduce the average computation time further it is desirable to have more classes and a larger selection of class optimized IDCT algorithms. To handle the problem if there is limited cache memory and a large number of block classes, only those algorithms corresponding to block classes which occur with the highest probability are stored in cache memory. In such a system, the probability of occurrence for each of the classes can be estimated off-line by computing statistics using a large number of MPEG2 video source sequences. This is referred to hereinafter as “off-line profiling.” The profile generated is a histogram estimating the probability a block will belong to a particular class.

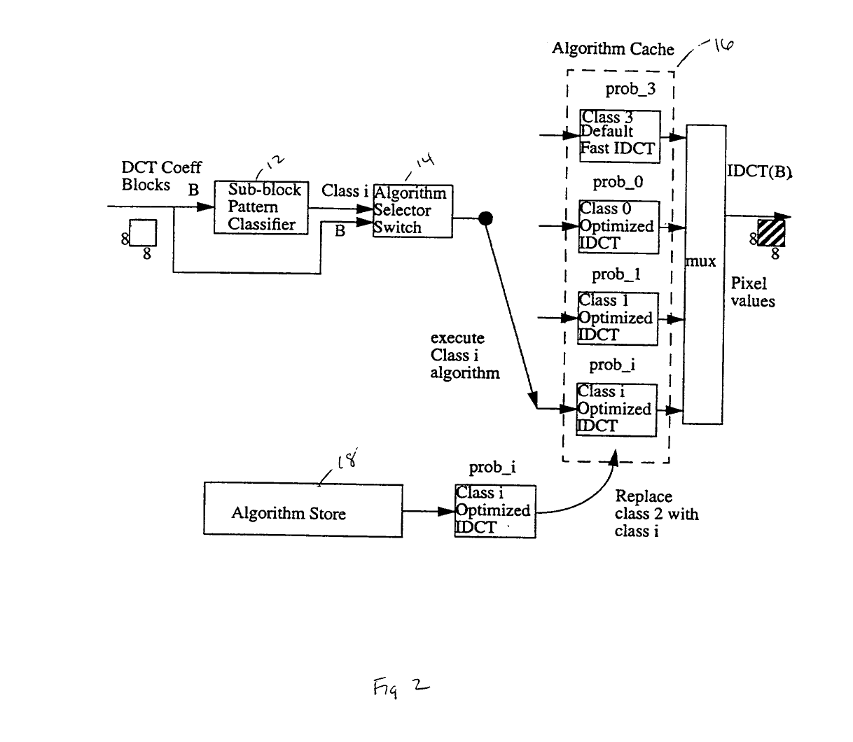

If the current data block to be processed belongs to a class for which the optimal algorithm is not loaded in cache the required algorithm can either be loaded into cache memory and thus pay the associated penalty, or execute the generic fast IDCT algorithm which can always be present in cache. FIG. 2 is a modification of the basic system of FIG. 1, taking into account the possibility of limited instruction cache memory making use of the “off-line profiling” statistics. The actual amount of code that fits into the cache 16 will depend on the hardware platform. For the purpose of illustration a cache is shown which can hold up to 4 versions of the fast IDCT algorithm. Initially the cache 16 is loaded with algorithms corresponding to the four most frequently occurring block classes. The current incoming block, B, is found to belong to class I. Since the optimized algorithm for the class I is not in cache 16 it is fetched from ordinary memory 18 and replaces the algorithm with the lowest probability (class 2). More sophisticated resource allocation schemes can be employed to manage the use of the cache 16.

If a low probability data type occurs for which no corresponding algorithm is loaded in the cache, then either the optimal algorithm can be fetched from slower memory 18 containing the store of all algorithms or a general purpose fast transform algorithm can be run that works on all classes of input data. Whether or not the missing algorithm is loaded into cache 16 or not depends on the cost associated with updating the cache 16. The general purpose algorithm is always to be stored in cache 16 and made available for execution.

The performance of the system in FIG. 2 can further be improved by using “runtime profiling” to monitor and update block class statistics, at runtime. In this way if there is a mismatch between the statistics gathered off-line and the actual block class statistics, the profile information can be updated and modified in the cache so that it actually contains the algorithms that are most frequently needed to be executed.

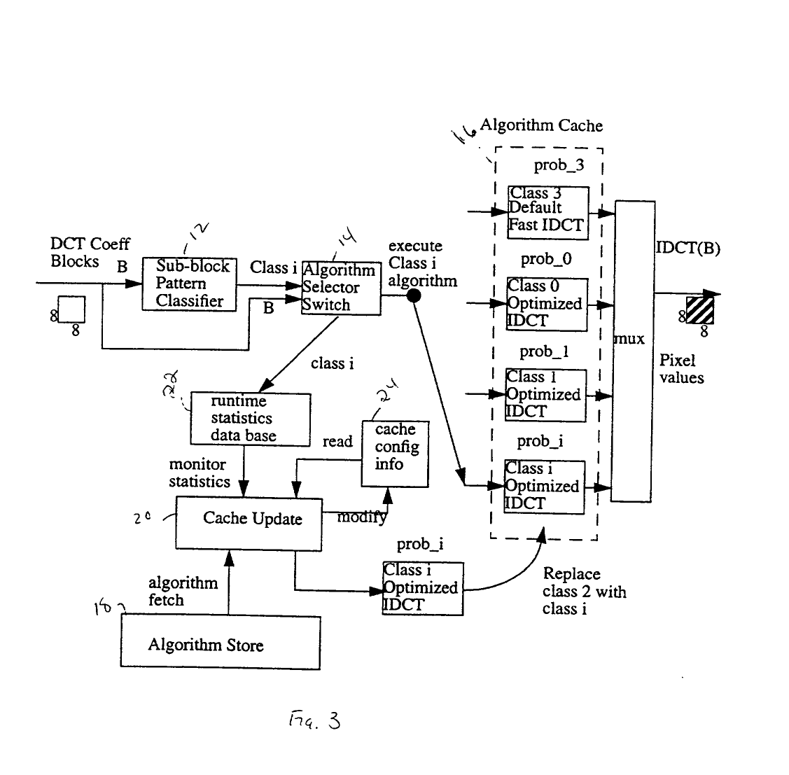

FIG. 3 shows a block diagram of a system where the cache is run-time updated. The cache 16 will take into account the fact that a particular video source may have a distribution of block classes that differs significantly from the distribution computed over a large number of video sources. The cache update module 20 has the responsibility of periodically checking the runtime statistics data base 22 which always contains the most current block class statistics. Using these statistics the cache update module 20 determines which are the four most likely block classes and checks the current cache configuration. If necessary, the cache 16 is updated from ordinary memory 18 so that the cache 16 contains the four most likely algorithms to be executed and modifies the cache configuration information store 24 to reflect the new cache configuration.

### Row and Column Histograms

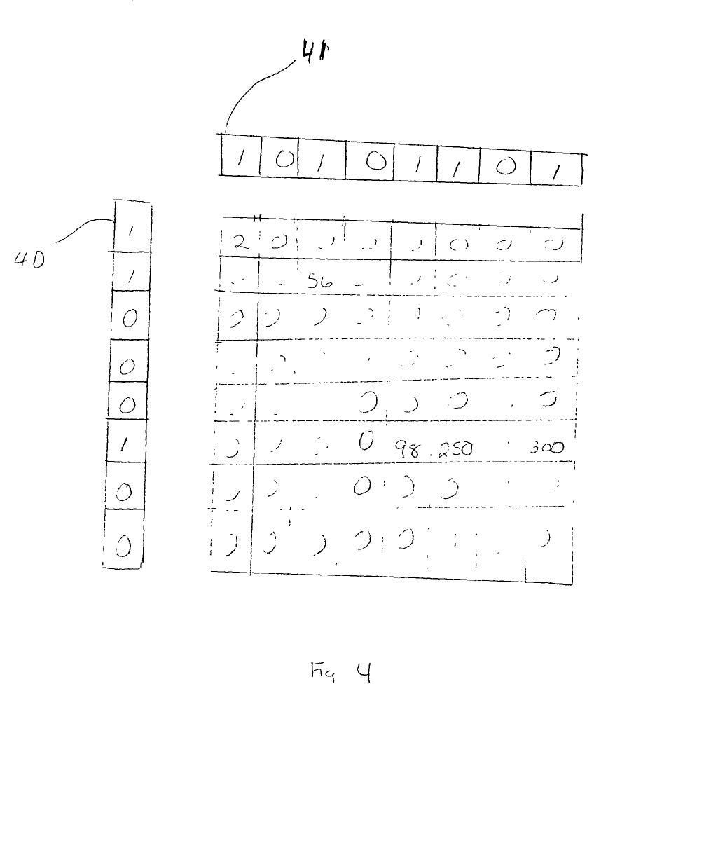

In a second embodiment of the invention (FIG. 4) the row and column location of each non-zero coefficient in a coded block is determined on a block by block basis during IQ/ISCAN. Each row or column in the inverse scanned matrix, which contains a non-zero coefficient is represented by a set bit in an 8-bit, bit vector. (FIG. 4) The most significant bit (Bit 7) of the vector represents column zero (or row zero) and the least significant bit represents column seven (or row seven). Two bit-vectors are generated, one a row histogram 40, and the other a column histogram 41. The procedure for generating the histograms during IQ/ISCAN is as follows:

I. Accumulate the run values associated with each coefficient and use the accumulated run value to look-up the row major matrix position of each coefficient.

ii. Using each coefficient's row major position in the matrix, determine its bit position in the column histogram as follows:

column position=BIT7>>(rmc MODULO N)

where

N is the number of elements per row, i.e., number of columns.

>> is a binary right-shift operator.

BIT7 is a constant bit-vector with all but the most significant bit set to zero.

rmc is the row-major count of the coefficient after ISCAN.

iii. Each time the state of a bit in the vector changes from a 0 to a 1 a counter is incremented. The degree of sparseness of the columns of the block is tracked this way.

iv. Using each coefficient's row major position, determine its bit position in the row histogram as follows:

row position=BIT7>>(rmc/N)

where

N is the number of elements per row, i.e., number of columns.

>> is a binary right-shift operator.

BIT7 is a constant bit-vector with all but the most significant bit set to zero.

rmc is the row-major count of the coefficient after ISCAN.

V. Each time the state of a bit in the row bit-vector changes from a 0 to a 1 a counter is incremented. The degree of sparseness of the rows of the block is tracked this way.

vi. Compare the row histogram versus the column histogram. The histogram with the fewest number of set bits (i.e. the sparser of the two), indicated by the respective counts, is passed on in the stream to affect column/row skipping in the first pass of the IDCT.

One goal of gathering block statistics during IQ/SCAN is to pass this information on to the IDCT phase. To do this, a data structure is created which can be associated with header data that is already passed along with the coefficient data at the output of the IQ/ISCAN process. Alternatively the block statistics data can be embedded in the coefficient data. This is achieved by encoding the block statistics in the high-word of the first coded coefficient of the block. For intra blocks, this high-word represents the dc-precision of the DC coefficient. For non-intra blocks this high-word is the RUN value of the first non-zero coefficient, so only the bits above Bit-05 are used to encode the block statistics results. One possible representation is the following:

Bit 15 0=column/row vector 0 empty; 1=not

Bit 14 0=column/row vector 1 empty; 1=not

Bit 13 0=column/row vector 2 empty; 1=not

Bit 12 0=column/row vector 3 empty; 1=not

Bit 11 0=column/row vector 4 empty; 1=not

Bit 10 0=column/row vector 5 empty; 1=not

Bit 09 0=column/row vector 6 empty; 1=not

Bit 08 0=column/row vector 7 empty; 1=not

Bit 07 1=Histogram in bits 15-8 is a column histogram

0=Histogram in bits 15-8 is a row histogram

Bit 06 1 F{[7] [7] ˆ =b 1; i.e. apply mismatch control

0 No action

Bit 05-Bit 00 contain the row-major position of the coefficient.

The disadvantage of this approach, is that the number of parameters that can be passed in this manner is restricted.

The most sparse histogram 40 is then passed on to the IDCT stage. The IDCT stage then only performs inverse discrete (FIG. 4) cosine transformation on the first, second and sixth rows of the block. The process of IDCT causes the values in the columns to change so all columns must be subjected to IDCT.

### Dynamic Range Statistics

In another embodiment of the invention the dynamic range of a block is computed. Blocks contain some arrangement or distribution of DCT transformed coefficients. The arrangement of coefficients in the blocks depend on how the block was coded. Coded blocks may contain as few as one coefficient or as many as sixty-four coefficients (blocks that are not coded are all zero). Coded blocks may contain coefficients that range in value from −2048 to +2047. Depending on whether the block is coded as intra or non-intra, coefficients may tend to be clustered in the upper left quadrant of the block (intra) and thus the block classification system should be used, or be randomly scattered within the block (non-intra). A good many blocks, however, will tend to have very few coefficients, and the dynamic range of these coefficients will tend to be small (−100 to −100).

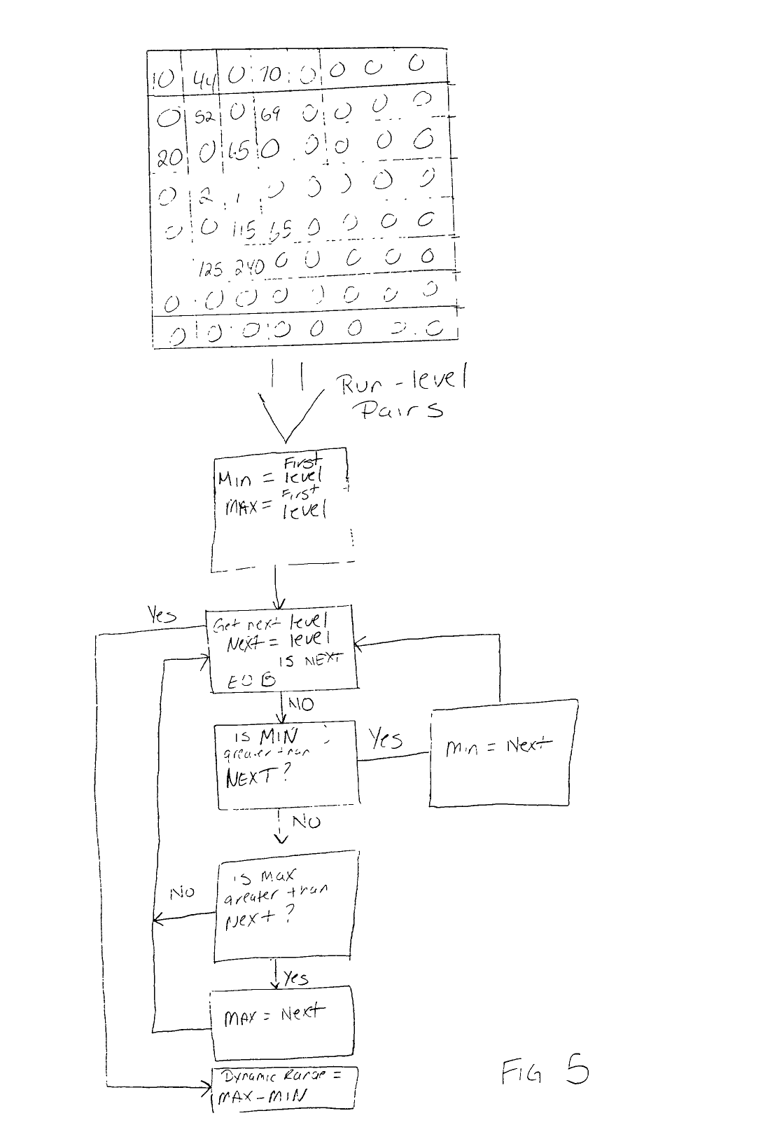

It is useful to know the dynamic range of the DCT coefficients in each block so that techniques such as Basic Matrix Expansion IDCT, as explained in U.S. Ser. No. 09/000,667, hereby incorporated by reference, may be applied to improve the efficiency of the decoder. The dynamic range of a block is computed in the following manner (FIG. 5):

MAX (level)−MIN (level)

where level is the dequantized level value of each run/level pair;

MAX ( ) compares each new level value against the previous largest value of the block and keeps the larger of the two;

MIN ( ) compares each new level value against the previous smallest of the block and retains the small of the two.

The dynamic range is then passed to the IDCT stage.

As explained above there are many types of block statistics that can be gathered during IQ/ISCAN and there are many uses for these statistics by the IDCT stage which will be apparent to one skilled in the art.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

In the claims:

1. A method of selecting an IDCT algorithm, comprising the steps of:
receiving a block of DCT data including a plurality of sub-blocks;
determining during IQ/ISCAN which sub-blocks contain non-zero DCT coefficients; and
selecting an IDCT algorithm for the block in dependence on the pattern of sub-blocks containing non-zero DCT coefficients within the block.

2. The method in accordance with claim 1, further including the step of:
modifying the selected IDCT algorithm such that at least some of the computations involving sub-blocks which contain all zero valued DCT coefficients are eliminated.

3. The method in accordance with claim 1, further including the steps of:
determining the probability of occurrence of blocks having particular patterns of sub-blocks with non-zero DCT coefficients; and
choosing and storing an optimal IDCT algorithm for blocks having a pattern of non-zero sub-blocks that have a high probability of occurrence, and choosing a default IDCT algorithm for the remaining blocks.

4. The method in accordance with claim 3, wherein the step of determining the probability of occurrence is based on a large number of MPEG2 video source sequences.

5. The method in accordance with claim 3, wherein the step of determining the probability of occurrence is based on the incoming video data and wherein the optimal IDCT algorithms are updated with new IDCT algorithms based on the non-zero sub-block patterns, on a run-time basis, that have a high probability of occurrence.

6. An electronic device for classifying blocks of DCT data, comprising:
a classifier which classifies each block of DCT data into a class based on the pattern of non-zero sub-blocks within the block; and
a class indicator which indicates the class of the block by providing a class indicating signal; and
an IDCT algorithm selector for selecting, based on class, an IDCT algorithm for the block.

7. An electronic device as claimed in claim 6, further including
a memory which stores the IDCT algorithms for those classes having a high probability of occurrence and which stores a default IDCT algorithm for those classes having a low probability of occurrence.

8. An electronic device as claimed in claim 6, wherein the blocks of DCT data have an 8×8 dimension and the sub-blocks are 4×4 sub-blocks.

9. An electronic device, comprising:
an input device which receives blocks of DCT data; and
a sub-block pattern classifier which detects during IQ/ISCAN non-zero sub-blocks containing non-zero DCT coefficients and which classifies each block into one of a set of classes based on the number and location of the non-zero sub-blocks within the block and which generates a class indicating signal which indicates the class of a block.

10. An electronic device, as claimed in claim 9, further including a memory which stores at least one optimal IDCT algorithm which is optimal for at least one class having a highest probability of occurrence and which stores a default algorithm for remaining classes, and wherein the at least one optimal IDCT algorithm and default algorithm are retrieved from the memory in dependence on the class indicating signal.

11. An electronic device as claimed in claim 10, wherein the memory is a cache memory, and wherein the electronic device further includes a second memory which stores additional optimal IDCT algorithms for classes having a low probability of occurrence.

12. An electronic device, comprising:
an input device which receives blocks of DCT data;
a sub-block pattern classifier which detects during IQ/ISCAN non-zero sub-blocks containing non-zero DCT coefficients and which classifies each block into one of a set of classes based on the number and location of the non-zero sub-blocks within the block and which generates a class indicating signal which indicates the class of a particular block;
an algorithm selector which receives the class indicating signal and selects an optimal IDCT algorithm corresponding to the class indicated by the class indicating signal; and
a memory which stores the optimal IDCT algorithms for the classes having a high probability of occurrence and which stores a default algorithm for classes having a low probability of occurrence.

13. The electronic device as claimed in claim 12, further including a probability determiner which determines the probability of occurrence of the classes based on the incoming blocks of DCT data and wherein the electronic device further includes a memory update device which updates the memory, on a run time basis, with the optimal IDCT algorithms of the classes having the highest probability of occurrence.

14. The electronic device as claimed in claim 12, wherein the probability determiner computes the probability of occurrence of each class off-line using a large number of video source sequences and wherein the optimal IDCT algorithms for the classes having the highest probability of occurrence are pre-stored in the memory.

15. The electronic device as claimed in claim 12, wherein the stored optimal IDCT algorithms have been modified to eliminate unnecessary computations with the sub-blocks that contain all zero-valued DCT coefficients.

16. The electronic device as claimed in claim 13, wherein the memory is a cache memory and the IDCT algorithms are retrieved from ordinary memory to update the cache with the optimal IDCT algorithms for the classes having the highest probability of occurrence.

17. An electronic device for improving the efficiency of IDCT, comprising:
a block statistic gatherer which gathers block statistics about a block of DCT coefficients during IQ/ISCAN relating to the composition of the DCT coefficients within the block, wherein the block statistics pertain to statistics relating to the block of DCT coefficients as a whole; and
a block statistic provider which provides the block statistics to an IDCT stage of a video decoder.

18. The electronic device, as claimed in claim 17, wherein the block statistics indicate the rows of the block that contain non-zero DCT coefficients.

19. The electronic device as claimed in claim 17, wherein the block statistics indicate the columns of the block that contain non-zero DCT coefficients.

20. The electronic device as claimed in claim 17, wherein the block statistics are one of I) an indication of the rows of the block that contain non-zero DCT coefficients, and ii) an indication of the columns of the block that contain non-zero DCT coefficients, whichever indication is less.

21. The electronic device as claimed in claim 17, wherein the block statistics are the dynamic range of the DCT coefficients within the block.

22. The electronic device as claimed in claim 17, further including means for encoding the block statistics in the DCT data for transfer to the IDCT stage.

23. The electronic device as claimed in claim 22, wherein the block statistics are encoded in a high word of a first coded coefficient of the block.

24. A method of improving the efficiency of IDCT, comprising the steps of:
gathering block statistics during IQ/ISCAN about the composition of DCT coefficients within a block of video data, other than run-level information; and
providing the block statistics to an IDCT stage of a video decoder.

25. The method as claimed in claim 24, wherein the step of gathering includes detecting rows of the block which contain non-zero DCT coefficients.

26. The method as claimed in claim 24, wherein the step of gathering block statistics includes detecting columns of the block which contain non-zero DCT coefficients.

27. The method as claimed in claim 24, wherein the step of gathering block statistics includes determining the dynamic range of the block.

28. The method as claimed in claim 24, further including the step of:
encoding the block statistics in the DCT data for transfer to the IDCT stage.

29. The method as claimed in claim 28, wherein the step of encoding encodes the block statistics in a high word of a first coded coefficient of the block.

30. A digital television receiver system, comprising:
a memory which stores computer executable block statistic gathering process steps;
inverse quantizer and inverse scanner capable of performing inverse quantization and inverse scan on a block of DCT coefficients; and
a controller which executes the process steps stored in the memory in conjunction with the inverse quantizer and inverse scanner performing inverse quantization and inverse scan, and which gathers block statistics about the block of DCT coefficients relating to the composition of the DCT coefficients within the block.

31. A digital television receiver system, as claimed in claim 30, further including an encoder for encoding the block statistics into the DCT coefficients.

32. A digital television receiver system, as claimed in claim 30, wherein the block statistics comprise at least one of a.) rows of the block that contain non-zero DCT coefficients, b.) columns of the block that contain non-zero DCT coefficients, c.) the dynamic range of the block and d.) information relating to sub-blocks within the block that contain non-zero coefficients.
